(19) United States
(12) Patent Application Publication
(10) Pub. No.: US 2026/0131802 A1
(43) Pub. Date: May 14, 2026

(54) FLAT TIRE DETECTION SYSTEM IMPLEMENTING ACCELERATION DATA

(71) Applicant: State Farm Mutual Automobile Insurance Company, Bloomington, IL (US)

(72) Inventors: Chad Brandon Witt, Bloomington, IL (US); Michael A. Best, Mesa, AZ (US); Jeffrey Adam Legner, Bloomington, IL (US)

(73) Assignee: State Farm Mutual Automobile Insurance Company, Bloomington, IL (US)

(21) Appl. No.: 18/945,297

(22) Filed: Nov. 12, 2024

(51) Int. Cl. B60W 50/029; B60W 50/02; B60W 50/14; G06N 20/00

(52) U.S. Cl. CPC B60W 50/029; B60W 50/0205; B60W 50/14; G06N 20/00; B60W 2050/021; B60W 2520/105; B60W 2556/10; B60W 2556/45

(57) ABSTRACT

A system may include one or more processors, and one or more non-transitory, computer-readable media including instructions which, when executed by the one or more processors, cause the one or more processors to obtain, using one or more sensors of a sensor device, acceleration data associated with a vehicle, determine, based on the acceleration data, a vehicle condition of a plurality of predefined vehicle conditions, in response to the determined condition including a flat tire, query a database using an identifier of the vehicle to determine service coverage for the vehicle, determine one or more response actions based on the service coverage for the vehicle and a location of the vehicle, and cause implementation of at least one of the one or more response actions.

### TECHNICAL FIELD

The present disclosure generally relates to flat tire detection on vehicles. More particularly, the present systems and methods relate to detecting vehicle flat tires using sensor data, such as acceleration data.

### BACKGROUND

Tire deflation or tire damage can cause vehicle damage, especially if not addressed in a timely manner. However, responses to tire deflation and tire damage vary across different vehicle types, and not all response actions are available for all vehicles and all geographic locations. For example, some vehicles are not equipped with spare tires, and some geographic locations do not have tire repair services.

### BRIEF SUMMARY

Aspects of the present disclosure are directed to a system, including one or more processors, and one or more non-transitory, computer-readable media including instructions which, when executed by the one or more processors, cause the one or more processors to obtain, using one or more sensors of a sensor device, acceleration data associated with a vehicle, determine, based on the acceleration data, a vehicle condition of a plurality of predefined vehicle conditions, in response to the determined condition including a flat tire, query a database using an identifier of the vehicle to determine service coverage for the vehicle, determine one or more response actions based on the service coverage for the vehicle and a location of the vehicle, and cause implementation of at least one of the one or more response actions.

In some implementations, the sensor device includes a housing enclosing one or more accelerometers, wherein the housing is separate from and structured to be coupled to the vehicle. In some implementations, the instructions cause the one or more processors to determine the vehicle condition of the plurality of predefined vehicle conditions by identifying, based on the acceleration data, signals corresponding to a flat tire and determining, based on the acceleration data, that the vehicle has stopped. In some implementations, the instructions cause the one or more processors to determine, based on the acceleration data, that the vehicle has stopped by comparing a stopped time to a predetermined stop interval. In some implementations, the instructions cause the one or more processors to determine, based on the acceleration data, a severity of the flat tire, and determine the one or more response actions based on the service coverage for the vehicle, the location of the vehicle, and the severity of the flat tire. In some implementations, the one or more response actions include generating an alert including an indication of potential damage to the vehicle if the vehicle is driven without replacing the flat tire or driven after replacing the flat tire. In some implementations, the instructions cause the one or more processors to transmit repair instructions for replacing the flat tire to the mobile device. In some implementations, the one or more sensors capture the acceleration data in multiple dimensions, and wherein determining the vehicle condition of the plurality of predefined vehicle conditions includes comparing vertical acceleration data of the acceleration data to one or more predefined thresholds. In some implementations, the instructions cause the one or more processors to receive an indication of a selection of the one or more response actions at the mobile device. In some implementations, the selection of the one or more response actions causes the mobile device to place a call to a service provider associated with the service coverage for the vehicle.

Aspects of the present disclosure are directed to one or more non-transitory, computer-readable media including instructions which, when executed by one or more processors, cause the one or more processors to obtain time series acceleration data of one or more vehicles, the time series acceleration data labeled with labels indicating whether a flat tire occurred during capture of the time series acceleration data, execute a machine-learning model using the time series acceleration data to determine whether a flat tire occurred, and update the machine-learning model based on the labels to reduce a loss between flat tire determinations generated by the machine-learning model and actual flat tire occurrences indicated by the labels.

In some implementations, the instructions cause the one or more processors to obtain the time series acceleration data of each of the one or more vehicles from a sensor device that is separate from and coupled to the vehicle. In some implementations, the time series acceleration data includes historical time series acceleration data, and wherein the labels include user input regarding flat tires. In some implementations, the time series acceleration data includes a geolocation of the one or more vehicles. In some implementations, the labels indicate a location of the flat tire on the vehicle, and wherein the instructions cause the one or more processors to update the machine-learning model based on the labels to reduce a loss between flat tire location determinations generated by the machine-learning model and actual flat tire locations indicated by the labels. In some implementations, the labels indicate a severity of the flat tire, wherein the instructions cause the one or more processors to update the machine-learning model based on the labels to reduce a loss between severity determinations generated by the machine-learning model and actual severities indicated by the labels.

Aspects of the present disclosure are directed to a method, including obtaining, using one or more sensors of a sensor device separate from and coupled to a vehicle, acceleration data of the vehicle, determining, based on the acceleration data, that the vehicle has a flat tire, in response to the vehicle having a flat tire, querying a database using an identifier of the vehicle to determine service coverage for the vehicle, determining one or more response actions based on the service coverage for the vehicle and a location of the vehicle, and causing implementation of at least one of the one or more response actions.

In some implementations, determining that the vehicle has a flat tire includes executing a machine-learning model using as input the acceleration data. In some implementations, the method includes determining, based on the acceleration data, a severity of the flat tire, and determining the one or more response actions based on the service coverage for the vehicle, the location of the vehicle, and the severity of the flat tire. In some implementations, the one or more sensors capture the acceleration data in multiple dimensions, and wherein determining the vehicle condition of the plurality of predefined vehicle conditions includes comparing vertical acceleration data of the acceleration data to one or more predefined thresholds.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

FIG. 1 illustrates an example environment for vehicle flat tire detection.

FIG. 2 illustrates details of the sensor device of FIG. 1.

FIG. 3 is a flow chart illustrating operations of an example method for detecting vehicle flat tires.

FIG. 4 is a flow chart illustrating operations of an example method for detecting vehicle flat tires.

The Figures depict preferred embodiments for purposes of illustration only. One skilled in the art will readily recognize from the following discussion that alternative embodiments of the systems and methods illustrated herein may be employed without departing from the principles of the present embodiments described herein.

### DETAILED DESCRIPTION

Embodiments and implementations discussed herein relate to systems and methods for detecting vehicle flat tires. Conventional systems for detecting flat tires rely upon pressure sensors that are calibrated to determine when tire pressure is lower than a recommended tire pressure. However, pressure sensors may not be accurate at lower pressures corresponding to flat tires or damaged tires. Additionally, the cost and maintenance requirements of pressure sensors, and their integration into vehicle electronic systems preclude their use in many vehicles. Tire pressure monitoring systems including pressure sensors may be available in some vehicles but may not be available in all vehicles, such as older model vehicles or less expensive models. Further, such tire pressure sensors may alert a driver to the presence of a tire having a pressure lower than a predetermined amount but may not provide an indication of a severity of the decreased pressure (e.g., if the tire is flat or has lower pressure but is not fully flat or damaged) and/or may not provide any functions or tools for addressing the low pressure issue.

Embodiments and implementations described herein provide for flat tire detection. Some embodiments utilize a sensor device that can be attached to any vehicle and/or that uses low-power processes that allow the sensor device to draw power from its own battery and integrate with systems independent from the vehicle. Thus, flat tires can be detected with high accuracy without integrated vehicle sensors and without draining power from the vehicle battery, in some implementations.

In some embodiments, the sensor device can be attached to a vehicle and can capture acceleration data of the vehicle. The sensor device can transmit the acceleration data to a mobile device. The mobile device can transmit the acceleration data to an analytic server for analysis and/or analyze the acceleration data of the vehicle. In some implementations, a first component of flat tire detection can be acceleration data captured while the vehicle is moving. In an example, vibrations of the vehicle and/or vertical motion of the vehicle can indicate that one or more of the tires of the vehicle have lost pressure or are damaged. In some implementations, a second component of flat tire detection can be driving behavior corresponding to flat tires, such as reducing speed and/or pulling off to the side of the road. Embodiments and implementations described herein can implement one or both of these components of flat tire detection to accurately detect flat tires using the sensor device. In some implementations, rather than or in addition to transmitting the signal to an analytic server, the sensor device and/or the mobile device can perform part of all of the processing to detect the flat tire condition. Further, it should be appreciated that, in various embodiments, the analytic server can be implemented as a single computing system, a distributed computing system including multiple computing devices, a cloud computing service, or using any other computing architecture.

Moreover, embodiments and implementations described herein can automatically determine one or more response actions in response to the detected flat tire. The response actions can be based on a type of vehicle, a severity of the flat tire or tire damage, a location of the vehicle, service coverage associated with the vehicle, a maintenance history of the vehicle, driver preferences, and other response actions for responding to the flat tire. In some implementations, the response actions can be automatically selected to optimize between speed, cost, effectiveness, and/or user preferences. In this way, the flat tire detection is integrated into systems for mitigating and/or addressing the flat tire or tire damage.

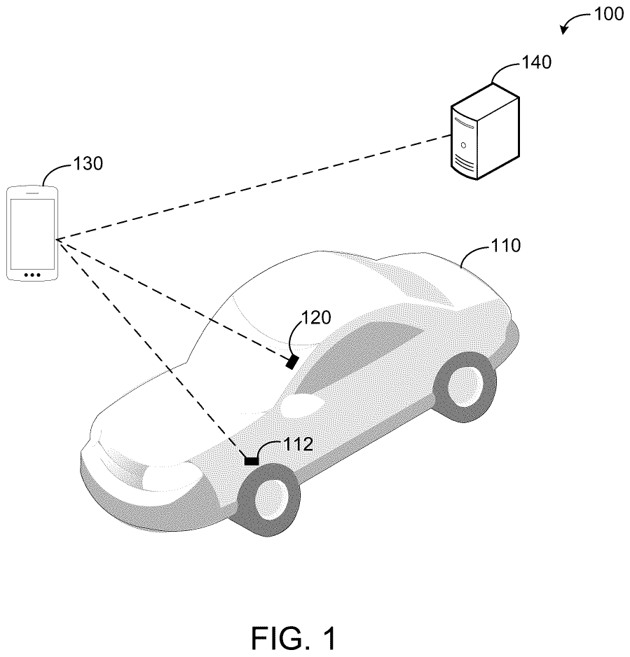

FIG. 1 illustrates an example environment 100 for flat tire detection. The environment 100 includes a vehicle 110, a sensor device 120, a mobile device 130, and a server 140. The vehicle 110 can include a vehicle sensor 112. The sensor device 120, the mobile device 130, and the server 140 (and in some cases the vehicle sensor 112) can communicate to detect vehicle flat tires on the vehicle 110.

The sensor device 120 includes one or more sensors that capture sensor data (e.g., time series sensor data), including acceleration data. The sensor device 120 can include one or more accelerometers to capture acceleration data in three dimensions. In an example, the sensor device 120 includes three accelerometers capturing acceleration data along three axes. In an example, the sensor device 120 includes a multi-axis accelerometer capturing acceleration data along three axes. The sensor device 120 can be coupled to the vehicle 110. In an example, the sensor device 120 is coupled to an interior surface of a windshield of the vehicle 110.

The sensor device 120 can capture sensor data (e.g., acceleration data) and transmit the sensor data to the mobile device 130 via a first network protocol, such as Bluetooth. In some implementations, the vehicle sensor 112 (e.g., pressure sensor) sends sensor data to the mobile device 130 via the first network protocol, or another network protocol. The mobile device 130 can transmit the sensor data to the server 140 via a second network protocol, such as a cellular network protocol, or the Internet. The server 140 can analyze the sensor data to determine characteristics of the sensor data. In some implementations, the server 140 determines events in the sensor data. In some implementations, the server 140 determines conditions in the sensor data corresponding to a plurality of predefined conditions. The server 140 can determine the conditions based on determined events in the sensor data. The server 140 can map events in the sensor data to the plurality of predefined conditions. In an example, the server 140 can determine an event in the sensor data that indicates that the vehicle came to a stop with a deceleration above a predetermined threshold, corresponding to a “hard stop” condition. In an example, the server 140 can determine an event in the sensor data that indicates that the vehicle accelerated from a stop with an acceleration above a predetermined threshold, corresponding to a “fast start” condition. In an example, the server 140 can determine an event in the sensor data that indicates that the vehicle experience lateral movement above a predetermined threshold, corresponding to a “swerving” condition.

The server 140 can execute one or more machine-learning models to determine the events and corresponding conditions in the sensor data. In some implementations, the server 140 executes a machine-learning model using as input the sensor data to determine the events in the sensor data and the corresponding conditions. The machine-learning model can be any type of machine-learning model such as a neural network, a convolutional neural network (CNN), a recurrent neural network (RNN), a transformer network, a support vector machine, a decision tree, an ensemble tree, a generalized additive model (GAM), a naïve Bayes classifier, a k-Nearest neighbor (KNN) classifier, a discriminant analysis classifier, or any other type of machine-learning model. In some implementations, the server 140 executes a first machine-learning model to determine a second machine-learning model to determine events in the sensor data. In an example, the server 140 executes a CNN to determine features of the sensor data and identify a transformer network based on the features of the sensor data to determine events in the sensor data.

In some implementations, the sensor device 120 analyzes the sensor data to determine one or more first preliminary characteristics of the sensor data and transmits the sensor data and the one or more first preliminary characteristics to the mobile device 130. In an example, the sensor device 120 executes a sensor device machine-learning model using as input the sensor data to generate the one or more first preliminary characteristics of the sensor data. In some implementations, the mobile device 130 analyzes the sensor data and/or the one or more preliminary characteristics to determine one or more second preliminary characteristics of the sensor data and transmits the sensor data and the one or more second preliminary characteristics to the server 140. In an example, the mobile device 130 executes a mobile device machine-learning model using as input the sensor data to generate the one or more second preliminary characteristics. In an example, the mobile device 130 executes the mobile device machine-learning model using as input the sensor data and the one or more first preliminary characteristics to generate the one or more second preliminary characteristics. In an example, the mobile device 130 executes the mobile device machine-learning model using as input the one or more first preliminary characteristics to generate the one or more second preliminary characteristics. In this way, the sensor device 120 and/or the mobile device 130 can determine preliminary characteristics of the sensor data. The server 140 can use the determined preliminary characteristics in determining the events in the sensor data.

The conditions determined using the sensor data can include driving behaviors and/or vehicle conditions such as tire pressure, deflated tires, and/or damaged tires. The vehicle conditions can be determined (e.g., by the sensor device 120, the mobile device 130, and/or the server 140) based on vibrations of the vehicle, movement of the vehicle, and/or associated driving behaviors. In an example, tire pressure can be determined from acceleration data based on vibrations of the vehicle corresponding to pressures of the tires of the vehicle. In this example, the vehicle vibrations can be compared to predefined vehicle vibration profiles for different types of vehicles or different makes and models of vehicles. In an example, a deflated tire can be determined from acceleration data based on increased vertical movement of the vehicle over the deflated tire. In some implementations, a flat tire (e.g., deflated tire, damaged tire) can be detected based on a combination of vibrations of the vehicle 110, increased vertical movement of the vehicle, and driving behavior such as pulling off to the side of the road. In some implementations, driving behavior such as pulling off to the side of the road can be determined based on determining that the vehicle 110 has stopped and comparing a stopped time to a predetermined stop interval. In addition, lateral acceleration of the vehicle 110 can be used to determine that the vehicle 110 is located on the side of the road. In this way, a full stop of the vehicle 110 can be distinguished from a temporary stop of the vehicle 110 such as a stop in traffic or a stop at a traffic light. In some implementations, sensor data can be used to determine whether the vehicle is on or off. In an example, vibrations from an engine of the vehicle 110 can indicate that the engine is running. In an example, direct communication from vehicle systems can indicate that the engine is running or that power is being drawn from a battery of the vehicle 110.

In some embodiments, one or more of the sensor device 120, the mobile device 130, or the server 140 execute one or more machine-learning models to determine the vehicle condition. In some implementations, the sensor device 120 transmits the sensor data captured by the sensor device 120 to the mobile device 130 which transmits the sensor data to the server 140 which executes a machine-learning model to determine whether the sensor data indicates a flat tire (e.g., loss of tire pressure above a predetermined threshold) or tire damage. In some implementations, the sensor device 120 transmits the sensor data captured by the sensor device 120 to the mobile device 130 which executes a preliminary machine-learning model to determine whether the sensor data indicates a flat tire or tire damage and transmits the sensor data and its determination to the server 140 which executes a more powerful (e.g., more accurate) machine-learning model to determine whether the sensor data indicates a flat tire or tire damage. In some implementations, the sensor device 120 captures the sensor data, executes a first machine-learning model (e.g., a machine-learning model having a lowest computational cost/complexity) to determine whether the sensor data indicates a flat tire or tire damage, and transmits the sensor data and its determination to the mobile device 130 which executes a second, intermediate (e.g., intermediate power and/or accuracy and/or having a medium computational cost/complexity) machine-learning model to determine whether the sensor data indicates a flat tire or tire damage and transmits the sensor data and its determination to the server 140 which executes a final (e.g., most accurate, most powerful and/or having a highest computational cost/complexity) machine-learning model to determine whether the sensor data indicates a flat tire or tire damage. In this way, different combinations of machine-learning models executed by the sensor device 120, the mobile device 130, and the server 140 can cooperate to provide an accurate determination of whether the sensor device indicates a flat tire or tire damage.

In some implementations, the sensor device 120, the mobile device 130, and/or the server 140 continuously execute their respective machine-learning models. In some implementations, each of the sensor device 120, the mobile device 130, and/or the server 140 execute a process or machine-learning model to determine whether to execute their respective machine-learning models to detect flat tires or tire damage. In an example, the server executes an orchestrator machine-learning model using as input the sensor data to determine further analysis to be performed on the sensor data, including executing a machine-learning model trained to detect flat tires or tire damage. In some implementations, the mobile device 130 and/or the server 140 execute their respective machine-learning models for detecting flat tires or tire damage in response to a determination by the sensor device 120 or the mobile device 130, respectively, that the sensor data indicates a flat tire or tire damage.

The mobile device 130 receives the acceleration data from the sensor device 120. In some implementations, the mobile device 130 retrieves the acceleration data from the sensor device 120. The mobile device 130 can execute a machine-learning model using as input the acceleration data to determine one or more events in the acceleration data to determine whether the acceleration data indicates a flat tire or tire damage. The mobile device 130 can use as input the acceleration data and any determinations made by the sensor device 120 to determine whether the acceleration data indicates a flat tire or tire damage. The mobile device 130 can transmit the acceleration data to the server 140 using a different communication protocol than used between the mobile device 130 and the sensor device 120. In an example, the mobile device 130 transmits the acceleration data to the server 140 via the Internet. In some implementations, the mobile device 130 transmits the acceleration data to the server 140 in response to determining that the acceleration data indicates a flat tire or tire damage. In some implementations, the mobile device 130 adds data to the acceleration data regarding a position or condition of the vehicle. In an example, the mobile device 130 determines a geolocation of the mobile device 130 and adds the geolocation to the acceleration data as a location of the detected flat tire or tire damage. In an example, the mobile device 130 determines a time of the acceleration data and adds the time to the acceleration data as a time of the detected flat tire or tire damage. In some implementations, the mobile device 130 receives additional data from the vehicle 110 to add to the acceleration data. In an example, the mobile device 130 receives a geolocation of the vehicle from the vehicle adds the geolocation received from the vehicle to add to the acceleration data.

The server 140 receives the acceleration data from the mobile device 130. The server 140 can execute a machine-learning model using as input the acceleration data to determine events within the acceleration data to determine whether the acceleration data indicates a flat tire or tire damage occurred. The server 140 can execute using as input the acceleration data, any determinations made by the sensor 120, and/or any determinations made by the mobile device 130. In some implementations, the server 140 executes a more powerful, more energy-intensive machine-learning model than is executed on the sensor device 120 or mobile device 130. In some implementations, the sensor device 120 executes a smallest, lowest-power machine-learning model, the mobile device 130 executes an intermediate-sized, intermediate-power machine-learning model, and the server 140 executes a largest, greatest-power machine-learning model to provide different levels of accuracy and/or precision in determining whether a flat tire or tire damage occurred. In some implementations, the server 140 receives the acceleration data in response to the sensor device 120 and/or the mobile device 130 determining that the acceleration data indicates that a flat tire or tire damage occurred.

In some implementations, the server 140 includes a database, or is communication with a database. The database can include a plurality of vehicle identifiers associated with service coverage. The service coverage associated with a vehicle identifier can indicate one or more services associated with the vehicle identifier such as roadside assistance, repair discounts, rental car coverage, and other services. The server 140 can receive a vehicle identifier of the vehicle 110 from the mobile device 130. The server 140 can query the database using the vehicle identifier to determine service coverage for the vehicle 110. In some implementations, the server 140 queries the database using the vehicle identifier of the vehicle 110 in response to a determination of a vehicle condition. In an example, the server 140 queries the database using the vehicle identifier of the vehicle 110 in response to a determination of a flat tire or tire damage. Querying the database using the vehicle identifier can include generating a query including the vehicle identifier and one or more parameters. In an example, the server 140 queries the database using a query including the vehicle identifier and a flat tire parameter to return service coverage information associated with flat tire repair.

The server 140 can determine one or more response actions based on the service coverage for the vehicle 110. In an example, the server 140 can determine a response action of contacting a tow truck company or causing the mobile device 130 to generate a notification regarding the tow truck company based on the service coverage including tow services. In an example, the server 140 can determine a response action of dispatching an emergency roadside assistance vehicle based on the service coverage including emergency roadside assistance. In an example, the server 140 can determine a response action of scheduling a repair at a vehicle repair station based on the service coverage including vehicle repair. In this example, the server 140 can identify the vehicle repair station based on the vehicle repair station being associated with the service coverage (e.g., the vehicle repair station being identified in the database).

In some implementations, the server 140 determines the one or more response actions based on the service coverage of the vehicle, a location of the vehicle, and/or a severity of the flat tire or tire damage. The location of the vehicle 110 can be received by the server 140 from the mobile device 130. The server 140 can determine the severity of the flat tire or tire damage based on the sensor data and/or indications from the mobile device (e.g., user input). The server 140 may determine an availability of response actions based on the location of the vehicle 110. In an example, the server 140 may determine that a tow service, but not an emergency roadside assistance service, is available in the location of the vehicle 110. The server 140 may determine a relevance of response actions based on the severity of the flat tire or tire damage. In an example, the server 140 may determine that self-repair of the tire is available based on a low severity of the flat tire. In an example, the server 140 may determine that the vehicle 110 can be driven to a vehicle repair station based on a low severity of the flat tire. In an example, the server 140 may determine that the vehicle cannot be driven on the flat tire based on the severity of the flat tire. In an example, the server 140 may determine that the vehicle cannot be drive on a replacement spare tire due to a severity of the flat tire or tire damage and potential damage to other components of the vehicle 110.

The one or more response actions can include notifying a user of the flat tire and/or the one or more response actions. The server 140, in response to determining that a flat tire or tire damage occurred, can transmit an alert to the mobile device 130 regarding the flat tire or tire damage and the determined one or more response actions. The mobile device 130, in response to the alert from the server 140, the alert from the sensor device 120, and/or a determination made by the mobile device 130 that a flat tire or tire damage occurred, can generate a notification to a user of the mobile device 130 regarding the flat tire or tire damage. In an example, the notification includes an indication of potential damage to the vehicle 110 if the vehicle 110 is driven without replacing the flat tire or if the vehicle 110 is driven after replacing the flat tire. In this way, the server 140 can provide multiple potential response actions to the mobile device 130 and the user. In some implementations, the notification at the mobile device 130 includes the one or more response actions for selection by the user. In response to selection of a response action of the one or more response actions by the user, the mobile device 130 and/or the server 140 can implement the selected response action. In an example, in response to receiving, at the mobile device 130, selection of a response action to contact a service provider associated with the service coverage for the vehicle 110, the mobile device 130 places a call to the service provider. In an example, in response to receiving, from the mobile device 130, an indication of selection of a response action to contact a service provider associated with the service coverage for the vehicle 110, the server 140 transmits a message to the service provider.

In some implementations, the one or more response actions include actions performed by a user of the mobile device 130, such as self-repair of the flat tire or tire damage and replacement of the flat tire with a spare tire. In an example, the server 140 transmits, to the mobile device 130, repair instructions for replacing the flat tire. In this example, the server 140 can retrieve a manual associated with the vehicle 110 including the repair instructions. In some implementations, the server 140 transmits text, video, or other media for repairing the flat tire or tire damage. In an example, the server 140 transmits, to the mobile device 130, an augmented reality overlay for the vehicle 110 for replacing the flat tire. In this example, the augmented reality overlay can indicate a location of a spare tire within the vehicle 110 and illustrate steps for replacing the flat tire with the spare tire.

It should be appreciated that the various architectures illustrated and described herein are provided for purposes of illustration only, and in various implementations, one or more of a variety of different architectures may be utilized. In some implementations, less components than illustrated in FIG. 1 may be utilized. For example, the sensor device 120 and/or the mobile device 130 may perform some or all of the processing functions described herein by itself or in combination with one another without utilizing one or more of the other devices (e.g., the server 140). In some such implementations, the sensor device 120 may perform the processing to detect whether a flat tire has occurred and may transmit an indication of the conclusion to the mobile device 130. In some implementations, the server 140 may be a single server or other computing device while, in other implementations, the server 140 may be implemented using a distributed or cloud computing environment using multiple computing devices. All such implementations are contemplated within the scope of the present disclosure.

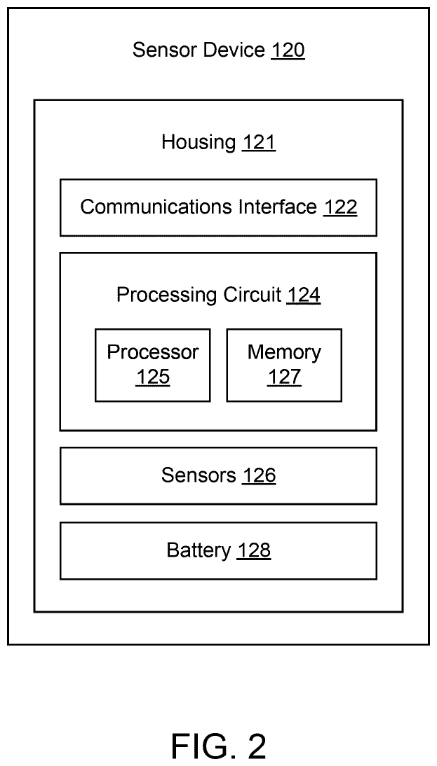

FIG. 2 illustrates details of the sensor device 120 of FIG. 1. The sensor device includes a housing 121. The housing 121 can be separate from and distinct from the vehicle 110. The housing 121 can be coupled to the vehicle to allow the sensor device 120 to capture acceleration data of the vehicle 110. The housing 121 encloses a communications interface 122, a processing circuit 124, sensors 126, and a battery 128.

The sensor device 120 can use the communications interface 122 to communicate with the mobile device 130, the vehicle sensor 112 (e.g., pressure sensor), the server 140, and other computing devices, such as a dashcam. The communications interface 122 can include one or more antenna for communicating using one or more communications protocols.

The processing circuit 124 receives sensor data from the sensors 126 to log and/or analyze the sensor data. The processing circuit 124 includes a processor 125 and a memory 127. The processor 125 can receive the sensor data from the sensors 126 and correlate the sensor data. In an example, the processor 125 receives time series acceleration data from three accelerometers capturing acceleration data along different axes and correlates the time series acceleration data into three-dimensional acceleration data. In an example, the processor 125 receives time series acceleration data from a multi-axis accelerometer capturing acceleration data along three different axes. The processor 125 can log (i.e., store) the sensor data in the memory 127. The processor 125 can execute lower-power processes to determine whether to execute higher-power processes such as execution of a machine-learning model.

The sensors 126 can include multiple different types of sensors including accelerometers, gyroscopes, barometers, sound sensors, and other sensors for capturing sensor data that can be used to determine whether a flat tire or tire damage occurred and/or for capturing sensor data that can be used to determine driving behavior.

The sensors 126, the processing circuit 124, and the communications interface 122 draw power from the battery 128. By drawing power from the battery 128, the sensor device 120 can operate independent of the vehicle 110 and a state of the vehicle 110, allowing the sensor device 120 to be coupled to any vehicle.

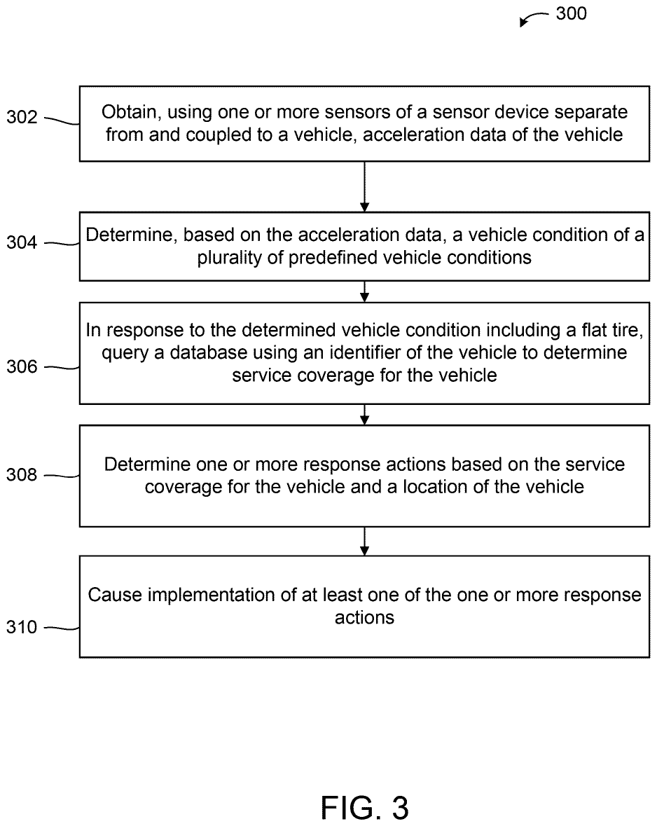

FIG. 3 is a flow chart illustrating operations of an example method for detecting parked vehicle collisions. The method 300 can include more, fewer, or different operations than shown. The operations can be performed in the order shown, in another order, or concurrently. The method e00 can be performed by one or more components in the environment 100 of FIG. 1, such as the sensor device 120, the mobile device 150, and/or the server 140. The method 300 can be performed by a computing device including one or more processors and one or more non-transitory, computer-readable media that, when executed by the one or more processors, cause the one or more processors to perform the operations of the method 300.

At operation 302, sensor data is obtained including accelerometer data of a vehicle captured by one or more sensors of a sensor device separate from and coupled to the vehicle. The sensor device can be the sensor device 120 of FIG. 1. Obtaining the sensor data can be performed via a communications protocol such as BLUETOOTH. In some implementations, the sensor data can be obtained by a server via a mobile device in communication with the sensor device.

At operation 304, a vehicle condition of a plurality of predefined vehicle conditions is determined based on the acceleration data. In some implementations, determining the vehicle condition of the plurality of predefined vehicle conditions includes identifying, based on the acceleration data, signals (e.g., vibrations) corresponding to a flat tire and determining, based on the acceleration data, that the vehicle has stopped. The combination of the signals corresponding to the flat tire and the stopping of the vehicle can provide a higher degree of confidence than the signals alone. In some implementations, determining that the vehicle has stopped includes comparing a stopped time of the vehicle to a predetermined stop interval. In some implementations, determining that the vehicle has stopped includes comparing lateral movement of the vehicle to an estimated distance to a side of the road to determine that the vehicle is stopped off of the road or on the side of the road. In some implementations, determining that the vehicle has stopped includes receiving data from the vehicle such as a geolocation or estimated location of the vehicle. In an example, an indication from the vehicle that the vehicle (based on its own sensor data) estimates that it is on the side of the road is used to determine that the vehicle is on the side of the road. In an example, an indication from the vehicle that vehicle sensor indicate damage to the vehicle is used to determine that the vehicle is damaged, and not simply stopped in traffic. In some implementations, the one or more sensors capture the acceleration data in multiple dimensions, and determining the vehicle condition of the plurality of predefined vehicle conditions includes comparing vertical acceleration data of the acceleration data to one or more predefined threshold. In some implementations, acceleration data in multiple dimensions can be used to determine a severity of the flat tire or tire damage. In an example, a vertical displacement above a predetermined threshold can indicate that the tire has lost a significant amount of pressure or that the tire has experienced a structural failure (e.g., blowout, delamination). In an example, acceleration (or deceleration) along a path of the vehicle above a predetermined threshold can indicate a rapid loss of speed due to a flat or damaged tire.

At operation 306, in response to the determined vehicle condition including a flat tire or tire damage, a database is queried using an identifier of the vehicle to determine service coverage for the vehicle. The identifier of the vehicle can be received from the mobile device. The identifier of the vehicle can be included in the acceleration data as metadata. The identifier of the vehicle can be determined based on the identifier of the vehicle being associated in the database or another database with an identifier of the sensor device.

At operation 308, one or more response actions are determined based on the service coverage for the vehicle and a location of the vehicle. In some implementations, a severity of the flat tire or tire damage is determined, and the one or more response actions are determined based on the service coverage for the vehicle, the location of the vehicle, and the severity of the flat tire. In this way, the one or more response actions are tailored to the circumstances of the flat tire or tire damage, as well as the service coverage of the vehicle. In an example, the one or more response actions include calling a tow truck in response to a severity of the flat tire requiring replacement or repair of the flat tire, a location of the vehicle near the tow truck, and a service coverage for the vehicle including tow truck services.

In some implementations, the one or more response actions include generating an alert including an indication of potential damage to the vehicle if the vehicle is driven without replacing the flat tire or driven after replacing the flat tire. In this way, the alert can notify a driver as to risks associated with driving the vehicle with the flat tire, after replacing the flat tire with a spare tire, or after patching the flat tire. The alert can help the driver understand the risks in order to make an informed decision between the one or more response actions. In an example, a driver chooses to incur a lesser expense of a tow truck instead of a greater expense of further damage to the vehicle caused by driving with tire damage.

At operation 310, implementation of at least one of the one or more response actions is caused. In some implementations, an indication of a selection of the one or more response actions at the mobile device is received. The selection of the one or more response actions can trigger implementation of the at least one of the one or more response actions. In an example, the one or more response actions can include calling a service provider associated with the service coverage for the vehicle, and a notification can be generated at the mobile device for calling the service provider. In this example, selection of the notification causes the mobile device to place a call to the service provider associated with the service coverage for the vehicle. In some implementations, the one response actions include transmitting repair instructions to the mobile device for replacing the flat tire. In an example, a notification is generated at the mobile device to prompt download of the repair instructions to allow the drive to repair or replace the flat tire.

In some implementations, the one or more response actions include contacting a service provider regarding the impact. In an example, the one or more response actions include generating a notification with a trigger to initiate a phone call or text conversation with an insurance provider or mechanic. In some implementations, the one or more response actions include initiating a phone call or text conversation with a mobile device of a user associated with the vehicle. In an example, the one or more response actions include prompting the user to document a status of the vehicle and/or to submit an insurance claim for damage to the vehicle caused by the impact.

In some implementations, the method 300 is performed by a sensor device, such as the sensor device 120 of FIG. 1. The one or more sensors can include sensors of the sensor device coupled to and separate from the vehicle and/or sensors of other devices, such as dashcams. The sensor device can include accelerometers to capture the accelerometer data. The sensor device can include a housing enclosing the one or more sensors, the one or more processors, and the one or more non-transitory, computer-readable media including the instructions that when executed, cause the one or more processors to perform the operations of the method 300. The housing is separate from and coupled to the vehicle. In an example, the housing is attached to an interior surface of a windshield of the vehicle using adhesive. In some implementations, the sensor device determines, using the sensor data, that the sensor data exceeds one or more predefined thresholds (e.g., acceleration thresholds). The sensor device, in response to the sensor data exceeding the one or more predefined thresholds, can execute the machine-learning model using as input the sensor data. The sensor device can transmit an alert to a mobile device and/or a server, such as the mobile device 130 and the server 140 of FIG. 1. In some implementations, the sensor device transmits the alert to the mobile device and the alert triggers a notification to inspect a status of the vehicle. In an example, the notification on the mobile device prompts a user to inspect the vehicle for damage. In an example, the notification on the mobile device prompts a user to record image and/or video data of the vehicle.

In some implementations, the method 300 is performed by a mobile device, such as the mobile device 130 of FIG. 1. The mobile device can obtain the sensor data from a sensor device, such as the sensor device 120 of FIG. 2. The mobile device can also function as a sensor device, using data from its own sensors, such as accelerometers, barometers, GPS modules, and other sensors. The mobile device can execute the machine-learning model, determine one or more response actions, and transmit the one or more response actions to a server, such as the server 140 of FIG. 1. In response to the mobile device determining that flat tire or tire damage occurred, the mobile device can determine the one or more response actions. In an example, the mobile device generates a notification to document a condition of the vehicle (e.g., describe a condition of the vehicle, record image and/or video data of the vehicle). The mobile device can correlate the sensor data from the sensor device with geolocation data captured by the mobile device and transmit the geolocation data to the server.

In some implementations, the method 300 is performed by a server, such as the server 140 of FIG. 1. In an example, the server receives the sensor data originating at a sensor device from a mobile device connected to the sensor device, executes the machine-learning model, and determines the one or more response actions to cause implementation of the one or more response actions. Implementation of the one or more response actions can including transmitting an alert to a mobile device to cause a user of the mobile device to provide information regarding the status of the vehicle (e.g., text, images, video) and/or select a response action of the one or more response actions. The mobile device can upload the information regarding the status of the vehicle to the server for storage and/or analysis and/or transmit the selection of the one or more response actions to the server 140 and/or implement the selected response action.

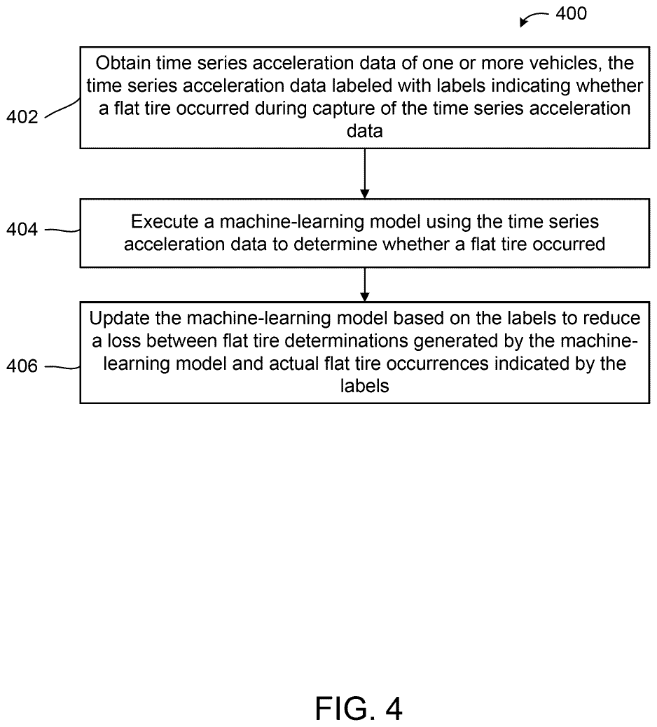

FIG. 4 is a flow chart illustrating operations of an example method for detecting parked vehicle collisions. The method 400 can include more, fewer, or different operations than shown. The operations can be performed in the order shown, in another order, or concurrently. The method 400 can be performed by one or more components in the environment 100 of FIG. 1, such as the sensor device 120, the mobile device 150, and/or the server 140. The method 400 can be performed by a computing device including one or more processors and one or more non-transitory, computer-readable media that, when executed by the one or more processors, cause the one or more processors to perform the operations of the method 400.

At operation 402, time series acceleration data of one or more vehicles are obtained. The time series acceleration data are labeled with labels indicating whether a flat tire occurred during capture of the time series acceleration data, or whether the acceleration data correspond to an occurrence of a flat tire. In some implementations, the time series acceleration data of each of the one or more vehicles is obtained from a sensor device that is separate from and coupled to the vehicle, such as the sensor device 120 of FIG. 1. In some implementations, the time series acceleration data includes historical time series acceleration data, and the labels include corresponding user input regarding flat tires. In an example, the historical time series acceleration data was captured by sensor devices and was labeled with user input indicating a flat tire. In some implementations, the time series acceleration data includes a geolocation and other metadata of the one or more vehicles.

At operation 404, a machine-learning model is executed using as input the time series acceleration data to determine whether a flat tire occurred. The machine-learning model can receive as input the time series acceleration data and any metadata of the time series acceleration data and output a prediction of whether the input (i.e., the time series acceleration data) indicates an occurrence of a flat tire.

At operation 406, the machine-learning model is updated based on the labels to reduce a loss between flat tire determinations made by the machine-learning model and actual flat tire occurrences indicated by the labels. The machine-learning model can be trained using a supervised training process, where the labels are used to reduce an error of the machine-learning model. The loss can be determined by a loss function and/or a fitness function to improve a performance of the machine-learning model, as indicated by a difference between the flat tire determinations generated by the machine-learning model and the labeled flat tire occurrences.

In some implementations, the labels indicate a location of the flat tire on the vehicle (e.g., which tire is flat or damaged). The machine-learning model can be updated based on the labels to reduce a loss between flat tire location determinations generated by the machine-learning model and actual flat tire locations indicated by the labels. In some implementations, the machine-learning model is trained to determine flat tire locations in a separate training stage from training to determine flat tire occurrences. In some implementations, the machine-learning model is trained in a single training stage to determine flat tire occurrences and flat tire locations.

In some implementations, the labels indicate a severity of the flat tire (e.g., loss in pressure, blowout, delamination, etc.). The machine-learning model can be updated based on the labels to reduce a loss between flat tire severity determinations generated by the machine-learning model and actual flat tire severities indicated by the labels. In some implementations, the machine-learning model is trained to determine flat tire severities in a separate training stage from training to determine flat tire occurrences. In some implementations, the machine-learning model is trained in a single training stage to determine flat tire severities and flat tire locations.

### Non-Limiting Example

In an example, a sensor device is attached on an interior surface of a windshield of a vehicle. The sensor device can connect to a mobile device of a driver of the vehicle to transmit acceleration data to the mobile device using a wireless protocol, such as Bluetooth. The mobile device can connect to a server using a different wireless protocol over a network such as the Internet. The server can execute a machine-learning model to analyze the acceleration data to determine events in the acceleration data to determine corresponding vehicle conditions from a plurality of predefined vehicle conditions. In response to determining that the acceleration data indicates that the vehicle has a flat tire, the server queries a database using an identifier of the vehicle to determine service coverage for the vehicle. The server determines one or more response actions based on the service coverage for the vehicle, a location of the vehicle, and a severity of the flat tire. The one or more response actions can include self-repair, calling a tow truck, calling emergency roadside assistance, and driving to a vehicle repair facility. The server causes the mobile device to generate a notification including the one or more response actions and a driver of the vehicle selects at least one of the one or more response actions. In response to the selection, the server causes implementation of the selected response action.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In some embodiments, a computer program is provided, and the program is embodied on a computer readable medium. In some embodiments, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method operations, actions, or functionality may be varied or re-sequenced according to alternative embodiments. Other substitutions, modifications, changes, and omissions can be made in the design, operating conditions, and arrangement of the example embodiments without departing from the scope of the present disclosure.

As used herein, an element or operation recited in the singular and proceeded with the word “a” or “an” should be understood as not excluding plural elements or operations, unless such exclusion is explicitly recited. Furthermore, references to “exemplary embodiment,” “one embodiment,” or “some embodiment” of the present disclosure are not intended to be interpreted as excluding the existence of additional embodiments that also incorporate the recited features.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The patent claims at the end of this document are not intended to be construed under 35 U.S.C. § 112(f) unless traditional means-plus-function language is expressly recited, such as “means for” or “step for” language being expressly recited in the claim(s).

Although the Figures show a specific order of method operations, actions, or functionality, the order of such may differ from what is depicted. Also, two or more operations, actions, or functionalities may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection operations or actions, processing operations or actions, comparison operations or actions, and decision operations or actions.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The term “coupled” and variations thereof, as used herein, means the joining of two members directly or indirectly to one another. Such joining may be stationary (e.g., permanent, or fixed) or moveable (e.g., removable, or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In various implementations, the functionality and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular industrial environment or portion of an industrial environment. Additionally or alternatively, the operations may be performed by a combination of one or more central or offsite computing devices/servers and one or more local controllers/computing devices. All such implementations are contemplated within the scope of the present disclosure.

Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A system, comprising:
one or more processors; and
one or more non-transitory, computer-readable media including instructions which, when executed by the one or more processors, cause the one or more processors to:
obtain, using one or more sensors of a sensor device, acceleration data associated with a vehicle;
determine, based on the acceleration data, a vehicle condition of a plurality of predefined vehicle conditions;
in response to the determined condition including a flat tire, query a database using an identifier of the vehicle to determine service coverage for the vehicle;
determine one or more response actions based on the service coverage for the vehicle and a location of the vehicle; and
cause implementation of at least one of the one or more response actions.

2. The system of claim 1, wherein the sensor device includes a housing enclosing one or more accelerometers, wherein the housing is separate from and structured to be coupled to the vehicle.

3. The system of claim 1, wherein the instructions cause the one or more processors to determine the vehicle condition of the plurality of predefined vehicle conditions by identifying, based on the acceleration data, signals corresponding to a flat tire and determining, based on the acceleration data, that the vehicle has stopped.

4. The system of claim 3, wherein the instructions cause the one or more processors to determine, based on the acceleration data, that the vehicle has stopped by comparing a stopped time to a predetermined stop interval.

5. The system of claim 1, wherein the instructions cause the one or more processors to:
determine, based on the acceleration data, a severity of the flat tire; and
determine the one or more response actions based on the service coverage for the vehicle, the location of the vehicle, and the severity of the flat tire.

6. The system of claim 1, wherein the one or more response actions include generating an alert including an indication of potential damage to the vehicle if the vehicle is driven without replacing the flat tire or driven after replacing the flat tire.

7. The system of claim 1, wherein the instructions cause the one or more processors to transmit repair instructions for replacing the flat tire to a mobile device.

8. The system of claim 1, wherein the one or more sensors capture the acceleration data in multiple dimensions, and wherein determining the vehicle condition of the plurality of predefined vehicle conditions includes comparing vertical acceleration data of the acceleration data to one or more predefined thresholds.

9. The system of claim 1, wherein the instructions cause the one or more processors to:
receive an indication of a selection of the one or more response actions at a mobile device.

10. The system of claim 9, wherein the selection of the one or more response actions causes the mobile device to place a call to a service provider associated with the service coverage for the vehicle.

11. One or more non-transitory, computer-readable media including instructions which, when executed by one or more processors, cause the one or more processors to:
obtain time series acceleration data of one or more vehicles, the time series acceleration data labeled with labels indicating whether a flat tire occurred during capture of the time series acceleration data;
execute a machine-learning model using the time series acceleration data to determine whether a flat tire occurred; and
update the machine-learning model based on the labels to reduce a loss between flat tire determinations generated by the machine-learning model and actual flat tire occurrences indicated by the labels.

12. The one or more non-transitory, computer-readable media of claim 11, wherein the instructions cause the one or more processors to obtain the time series acceleration data of each of the one or more vehicles from a sensor device that is separate from and coupled to the vehicle.

13. The one or more non-transitory, computer-readable media of claim 11, wherein the time series acceleration data comprises historical time series acceleration data, and wherein the labels comprise user input regarding flat tires.

14. The one or more non-transitory, computer-readable media of claim 11, wherein the time series acceleration data includes a geolocation of the one or more vehicles.

15. The one or more non-transitory, computer-readable media of claim 11, wherein the labels indicate a location of the flat tire on the vehicle, and wherein the instructions cause the one or more processors to update the machine-learning model based on the labels to reduce a loss between flat tire location determinations generated by the machine-learning model and actual flat tire locations indicated by the labels.

16. The one or more non-transitory, computer-readable media of claim 11, wherein the labels indicate a severity of the flat tire, wherein the instructions cause the one or more processors to update the machine-learning model based on the labels to reduce a loss between severity determinations generated by the machine-learning model and actual severities indicated by the labels.

17. A method, comprising:
obtaining, using one or more sensors of a sensor device separate from and coupled to a vehicle, acceleration data of the vehicle;
determining, based on the acceleration data, that the vehicle has a flat tire;
in response to the vehicle having a flat tire, querying a database using an identifier of the vehicle to determine service coverage for the vehicle;
determining one or more response actions based on the service coverage for the vehicle and a location of the vehicle; and
causing implementation of at least one of the one or more response actions.

18. The method of claim 17, wherein determining that the vehicle has a flat tire includes executing a machine-learning model using as input the acceleration data.

19. The method of claim 17, further comprising determining, based on the acceleration data, a severity of the flat tire; and
determining the one or more response actions based on the service coverage for the vehicle, the location of the vehicle, and the severity of the flat tire.

20. The method of claim 17, wherein the one or more sensors capture the acceleration data in multiple dimensions, and wherein determining the vehicle condition of the plurality of predefined vehicle conditions includes comparing vertical acceleration data of the acceleration data to one or more predefined thresholds.
